(19) United States
(12) Patent Application Publication
(10) Pub. No.: US 2005/0241594 A1
(43) Pub. Date: Nov. 3, 2005

(54) Grooming tool display and packaging system

(76) Inventors: Jonathan Willinger, Tenafly, NJ (US); Klaus Woltmann, Demarest, NJ (US)

Correspondence Address: KATTEN MUCHIN ROSENMAN LLP, 575 MADISON AVENUE, NEW YORK, NY, 10022-2585, US

(21) Appl. No.: 11/094,328

(22) Filed: Mar. 30, 2005

Related U.S. Application Data
(60) Provisional application No. 60/564,802, filed on Apr. 23, 2004.

(51) Int. Cl. A01K 13/00

(52) U.S. Cl. 119/625; 119/600

(57) ABSTRACT

A grooming tool display and packaging system aids a user in selecting a grooming tool that is appropriate for grooming the coat of a particular animal. The system includes a display sign for prominent display, which has categories for describing at least one coat type and indicia associated with one category. The system also includes a grooming tool package that is associated with the grooming tool, the package includes the indicia associated with the categories that the user selects so that the user selects the grooming tool that is appropriate for grooming the coat of a particular animal.

### CROSS-REFERENCE TO RELATED APPLICATION

This application claims priority to provisional patent application 60/564,802 having a filing date of Apr. 23, 2004.

### FIELD OF THE INVENTION

The present invention relates to a display and packaging system generally, and more particularly to a display and packaging system for grooming tools particularly suited for animals.

### BACKGROUND OF THE INVENTION

Pet dogs, cats and the like come in all different shapes and sizes and have a variety of hair and fur types. In fact, depending on the particular classification method used, there are anywhere from 5 to 7 different types of coats, the most common being short, medium, long, curly, flat and wiry. While each pet may be classified into at least one coat type, grooming tools presently on the market are generally suitable for more than one type.

There are approximately 30 standard grooming tools on the market. When faced with such variety, it is often difficult to associate the suitability of a particular grooming tool with a particular coat type. Accordingly, there is a need to provide consumers with a system for easily and quickly identifying and coordinating the approximately 30 standard grooming tools with a particular coat type. The problem is that each tool can be used with at least one, and in most cases three or four different coat types, which makes it difficult to easily and quickly convey the relevant associative information to the consumers.

### SUMMARY OF THE INVENTION

In accordance with the grooming tool display and packaging system of the present invention, informative signage is provided at a point-of-purchase location (e.g., retail store or trade show exhibition booth) behind or next to the grooming tool section, which signage gives the consumer an explanation of the different coat types and preferably includes a photo of a common pet with the coat type, and some other examples of pets with such coat type. Each coat type is designated on such signage by associative indicia, such as a distinctive color and/or logo and/or symbol. Such associative indicia are then conspicuously reproduced on the grooming tool packaging. Once the consumer identifies the coat type and recognizes the associative indicia, the consumer must merely look for such associative indicia on the grooming tool packages to determine the most suitable tools for a particular coat type.

### BRIEF DESCRIPTION OF THE DRAWINGS

FIG. 1 illustrates a grooming tool display and packaging system of the present invention.

FIG. 2 illustrates display signage posted at a point-of-purchase location that is used in the grooming tool display and packaging system of the present invention.

FIG. 3 illustrates one example of a grooming tool packaging utilizing the system of the invention.

FIG. 4 illustrates another example of a grooming tool packaging utilizing the system of the invention.

FIGS. 5A and 5B illustrate a grooming tool head and handle, respectively, with an indicia of the system of the invention.

### DETAILED DESCRIPTION OF THE PREFERRED EMBODIMENTS

The following detailed description is of the best mode or modes of the invention presently contemplated. Such description is not intended to be understood in a limiting sense, but to be an example of the invention presented solely for illustration thereof, and by reference to which in connection with the following description and the accompanying drawings one skilled in the art may be advised of the advantages and construction of the invention.

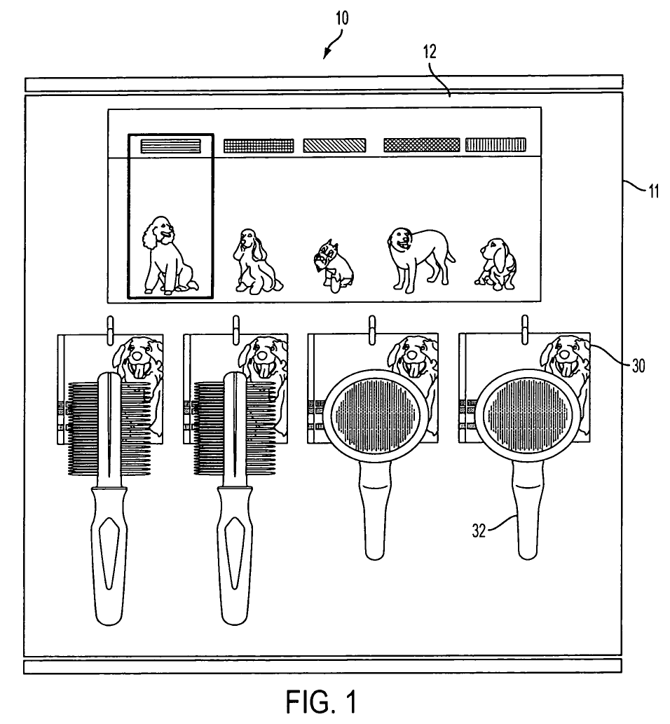

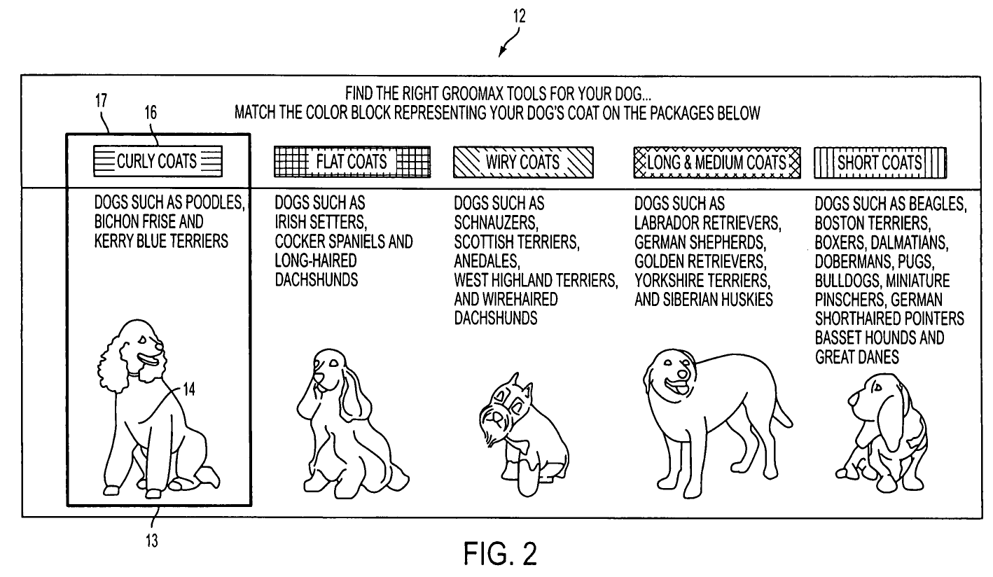

FIG. 2 illustrates one embodiment of an informative display signage 12 posted at a point-of-purchase location (e.g., retail store or trade show exhibition booth) that is used in the grooming tool display and packaging system 10 of the present invention. As shown in FIG. 1, display signage 12 is preferably posted adjacent to the grooming tools in a shelf or display unit 11 of the grooming tools section of a store or of a tradeshow display. Therein, display signage 12 is adjacent and/or near to grooming tool packaging 30 of tools 32.

Display signage 12 provides categories 13 for the different coat types and preferably includes a photo 14 of a common pet with the coat type, and some other examples of pets with such coat type.

Signage 12 illustrates five categories 13 of common coat types, namely curly, flat, wiry, long & medium and short. The animal photo 14 displayed in connection with each coat type is not intended to in any limiting sense, but is one example of a typical animal, other examples being listed in the embodiment of FIG. 2 above such photo 14. For example, a poodle is illustrated in photo 14 in connection with curly coats, and above such photo 14 it is indicated other common curly coat dogs “such as Poodles, Bichon Frise and Kerry Blue Terriers.”

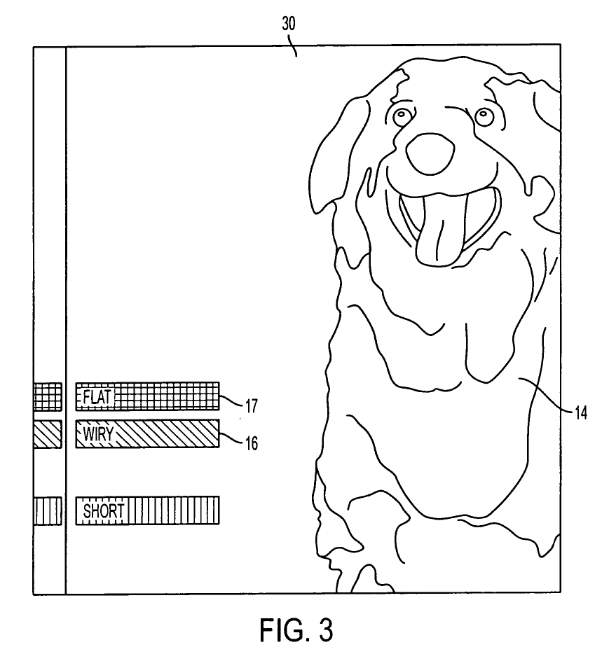

Each category 13 of coat type on the informative display signage 12 is designated by associative indicia 16, such as a distinctive color 17 and/or symbol 18 (as shown in FIG. 3). Further indicia 16 may be a logo or description, such as “CURLY”.

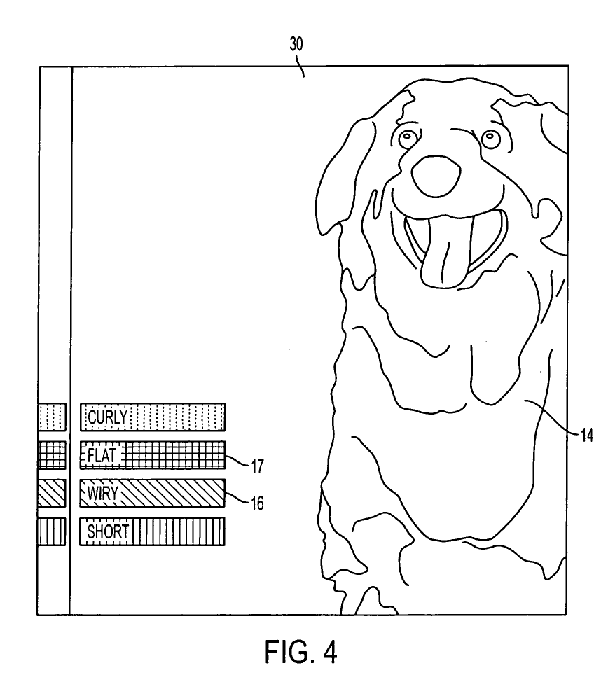

In the embodiment of FIG. 2, each category 13 of coat type is designated by a distinctive color 17 that is readily distinguishable from the other colors 17 when displayed together. For example, such colors might be purple, yellow, green, orange and red. Colors 17 that share common shades or basic color ingredients should preferably not be used to avoid general confusion when viewed from afar and in consideration of those consumers that are partially or completely color blind. Such associative indicia 16 are then conspicuously reproduced on the grooming tool packaging 30 as shown in the examples of FIGS. 3 and 4.

Once the consumer identifies the coat type from the display signage 12 and recognizes the associative indicia 16 the consumer can merely look for such associative indicia 16 on the grooming tool packages 30 to determine the most suitable tools for a particular coat type. For example, the slicker brush of FIG. 3 should be used with curly, flat, wiry and long & medium coats, but not with short coats. The same applies to the pin brush of FIG. 4. However, instead of trying to read the coat types on all of the displayed grooming tools, the consumer can merely quickly scan for the color 17 or other associative indicia 16 prominently and conspicuously displayed on the packaging to find the right match.

As noted above, the associative indicia 16 can be a distinctive color 17 and/or symbol 18. Other associative indicia 16 can be used as desired, such as, for example, a picture of the hair type such as a curly line for curly hair and a short “dash” for short hair. In addition, a combination of associative indicia 16 can be used to make the distinction of the coordinating packaging 30 even clearer, as shown for example in Table 1.

TABLE 1
Associative Indicia Examples

| Coat Type | Color Only | Shape Only | Colored Shape |
|---|---|---|---|
| Short | Red | Circle | Red Circle |
| Medium & Long | Orange | Square | Orange Square |
| Curly | Purple | Star | Purple Star |
| Wiry | Green | Pentagon | Green Pentagon |
| Flat | Yellow | Diamond | Yellow Diamond |

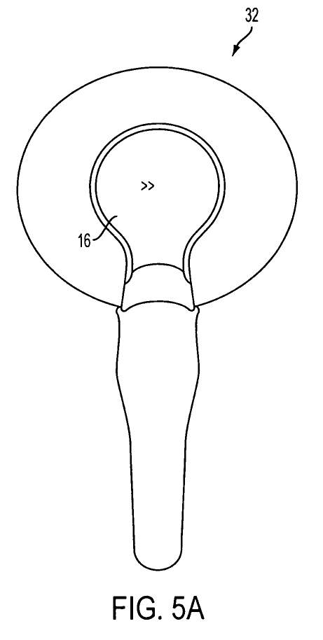

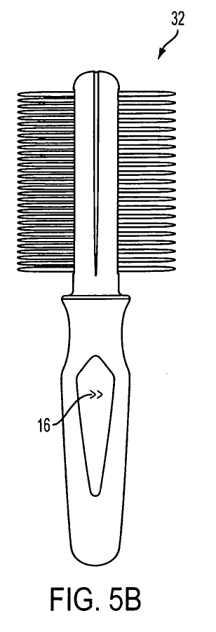

FIGS. 3 and 4 illustrate the placement of the associative indicia 16 on the grooming tool packaging 30. Indicia 16 may also be located in or on other areas such as the point-of-purchase display as shown in and/or on the tool 32 itself as shown FIGS. 5A. It might be desirable to have indicia 16 located on the tool itself, particularly if the consumer has multiple animals with non-analogous or uncooperative coat types, and because the packaging 30 is usually discarded prior to the first use of the tool. Examples of such settings might be multi-pet households, animal hospitals, veterinarians, grooming locations and the like. Once the packaging 30 is no longer associated with the grooming tool, it may be difficult to remember the category of coat type or types 13 associated with such tool 32.

Thus, as shown in FIGS. 5A and 5B, an indicia 16 of the hair type embossed on the head and/or handle of grooming tool 32 might be most instructive, as shown for example in Table 2.

TABLE 2
Symbolic Associative Indicia Example

| Coat Type | Possible Symbols |
|---|---|
| Short | -- |
| Medium & Long | — |
| Curly | ≈ |
| Wiry | >> |
| Flat | ≡ |

Continuing with the example shown in FIGS. 3 and 4, the handle of grooming tool 32 might have the following symbols 19 embossed thereon:

| | | | |
|---|---|---|---|
| — | ≈ | >> | ≡ |

Or, such tool 32 might have combinations of indicia 16 wherein symbols 19 and descriptions of the co:

| | | | |
|---|---|---|---|
| L/M | Curly | Wiry | Flat |
| — | ≈ | >> | ≡ |

Of course, such associative indicia 16 located on the grooming tool may be the same or different than that used on the packaging 30 and/or display signage 12, since certain indicia 16 may be more readily recognizable and distinguishable at the point of purchase. The goal is to enable consumers to readily select the most suitable grooming tool at the point of purchase, and then to use the most suitable tool if the household includes animals with more than one coat type.

While the present invention has been described at some length and with some particularity with respect to the described embodiments, it is not intended that it should be limited to any such particulars or embodiments or any particular embodiment, but it is to be construed so as to provide the broadest possible interpretation and to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

1. A grooming tool display and packaging system for aiding a user in selecting a grooming tool appropriate for grooming the coat of a particular animal, the system comprising:
a display sign for prominent display, the display sign including a plurality of categories for describing at least one coat type and an indicia associated with one category of the plurality of categories; and
a grooming tool package associated with a grooming tool, the grooming tool package including the indicia associated with the one category so that the user selects the grooming tool that is appropriate for grooming the coat of the particular animal.

2. The system of claim 1 wherein the indicia is one of color, logo and symbol.

3. The system of claim 2 wherein colors are provided that are not easily confused.

4. The system of claim 1 further wherein the grooming tool is disposed with the indicia associated with the one category of coat types.

5. The system of claim 4 wherein the indicia disposed on the grooming tool is embossed on one of a handle and a head of the grooming tool.

6. A set of grooming tools for grooming coats of animals, the set being adapted for aiding a user in selecting a grooming tool appropriate for grooming the coat of a particular animal, the set comprising:
a first grooming tool associated with a first indicia associated with a coat type, and
a second grooming tool associated with a second indicia associated with a second coat type;
wherein the user selects one of the first and second grooming tools so that the one grooming tool is appropriate for grooming the coat of the particular animal based on one of the first and second indicia.

7. The set of claim 6 wherein the first and second indicia are one of color, logo and symbol.

8. The set of claim 6 wherein the first and second indicia are embossed on one of a handle and a head of the respective grooming tool.

9. An system for aiding in selecting a grooming tool by a user for grooming the coat of a particular animal, the system comprising:
a plurality of categories of coat types of a plurality for describing at least one coat type of animals, and
at least one indicia associated with one category of the plurality of categories and associated with a plurality of grooming tools so that the user selects one of the plurality of grooming tools so that the one grooming tool is appropriate for grooming the coat of the particular animal.
